(19) United States
(12) Patent Application Publication
(10) Pub. No.: US 2007/0115629 A1
(43) Pub. Date: May 24, 2007

(54) MULTIFUNCTION MACHINE AND SUPPORTING STRUCTURE THEREOF

(75) Inventor: Shao Kui Lin, Jiangsu (CN)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/560,305

(22) Filed: Nov. 15, 2006

(30) Foreign Application Priority Data
Nov. 18, 2005 (TW) TW94140557

(51) Int. Cl. G06F 1/16

(52) U.S. Cl. 361/686

(57) ABSTRACT

A multifunction machine and a support structure thereof. The multifunction machine comprises a printing device, a scanning device and a supporting structure. The supporting structure comprises a supporting element and a guide groove. The supporting element comprises two connecting ends for connecting the printing device and the scanning device. The guide groove comprises a stop block. The stop block has a stop surface. When the scanning device is opened, one of the connecting ends in the guide groove passes the stop block, and then connects to the stop surface to keep the scanning device open.

### BACKGROUND OF THE INVENTION

1. Field of the Invention

The invention relates to a multifunction machine and a supporting structure thereof, and in particular relates to a multifunction machine maintaining a predetermined opening angle using a supporting structure.

2. Description of the Related Art

Referring to FIG. 1A, a conventional multifunction machine 10 comprises a printing device 11 and a scanning device 12. When an ink cartridge is empty, a user opens the scanning device 12 (the upper layer of the multifunction machine 10) to replace the empty ink cartridge with a full ink cartridge. However, no supporting structure keeps the scanning device 12 open, thus, one hand of a user supports the scanning device 12 and the other does the replacement of the ink cartridge which is very inconvenient.

### BRIEF SUMMARY OF INVENTION

A detailed description is given in the following embodiments with reference to the accompanying drawings. The invention provides a multifunction machine comprising a printing device, a scanning device and a supporting structure therebetween. The supporting structure comprises a supporting element and a guide groove. The guide groove comprises at least a stop block having a stop surface. When the scanning device moves from a closed position to an open position, the connecting end in the guide groove passes the stop block and is then propped against the stop surface for keeping the scanning device open at a predetermined angle.

### BRIEF DESCRIPTION OF DRAWINGS

The invention can be more fully understood by reading the subsequent detailed description and examples with references made to the accompanying drawings, wherein:

FIG. 1A is schematic view of a conventional multifunction machine which the scanning device closes;

FIG. 1B is schematic view of a conventional multifunction machine showing the scanning device as it opens;

FIG. 2 is schematic view of a multifunction machine of the invention showing the scanning device as it closes;

FIG. 3A is schematic view of a multifunction machine of the invention showing the scanning device as it opens;

FIG. 3B is an enlarged view of FIG. 3A;

FIG. 4A is a cross-sectional view along 4-4 of FIG. 2;

FIGS. 4B-4F show the process of a scanning of a multifunction machine closing; and

FIG. 5 shows another embodiment of a multifunction machine.

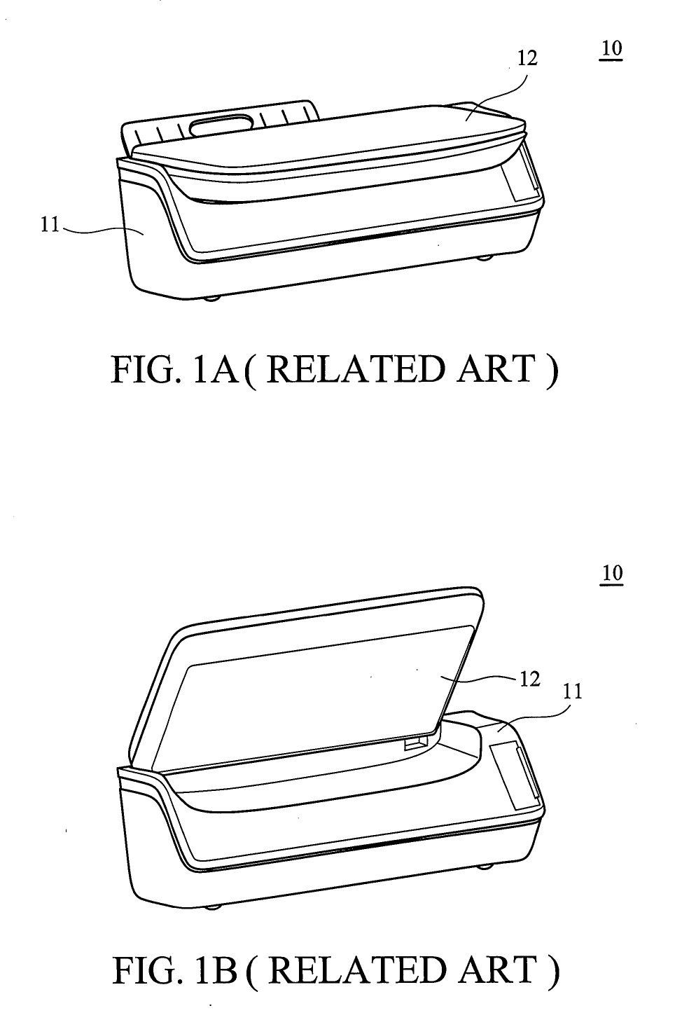

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

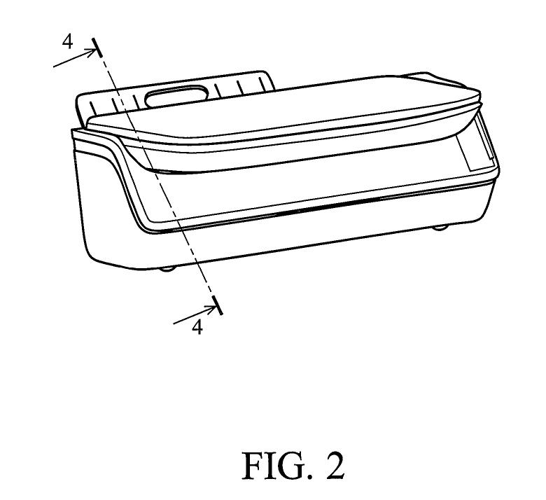

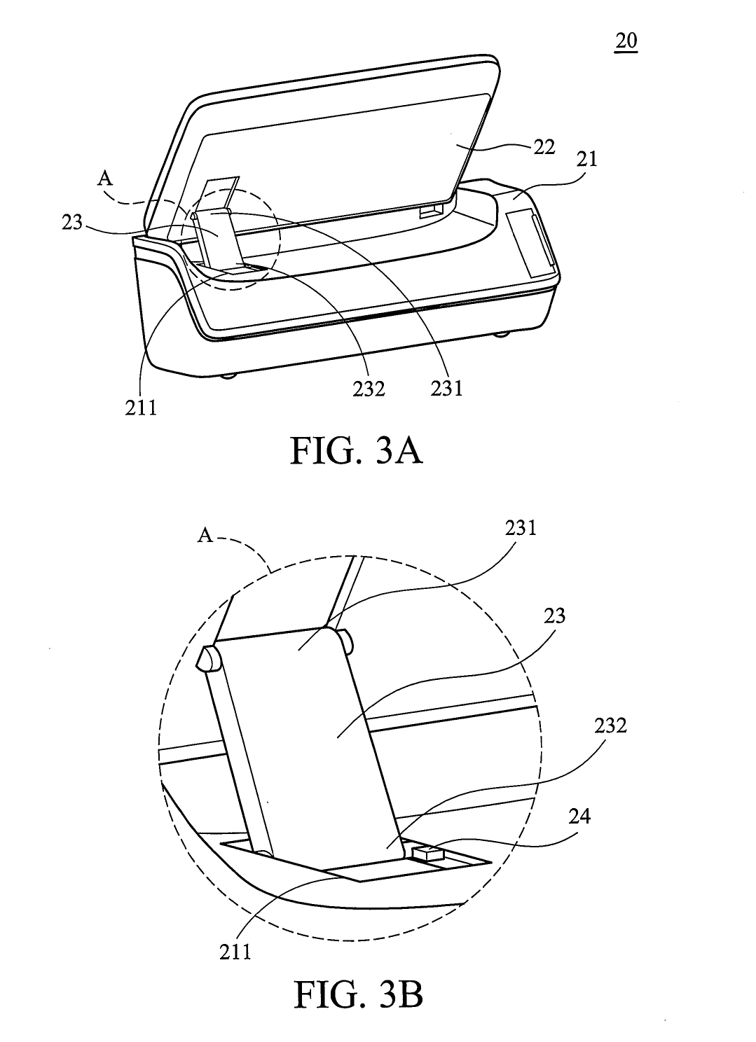

Referring to FIGS. 2 and 3A, the multifunction machine 20 comprises a printing device 21 and a scanning device 22. An ink cartridge (not shown) is installed in the printing device 21. The printing device 21 comprises a guide groove 211. A supporting element 23 connected between the printing device 21 and the scanning device 22 comprises two connecting ends 231 and 232. The connecting end 231 and scanning device 22 are connected on a pivot. The connecting end 232 is installed movably in the guide groove 211.

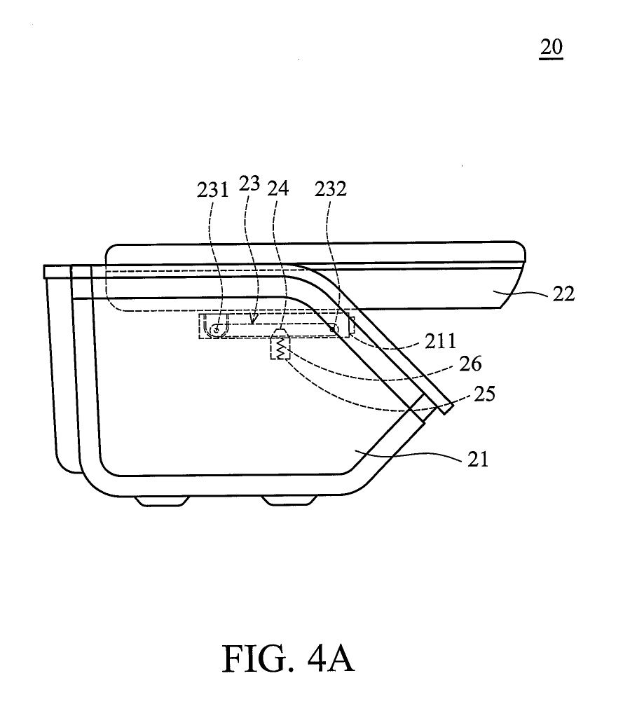

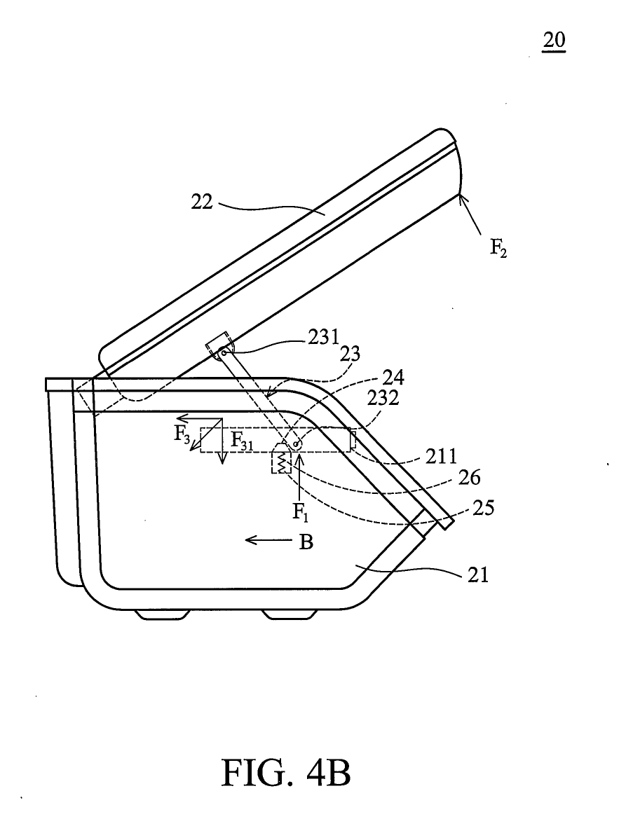

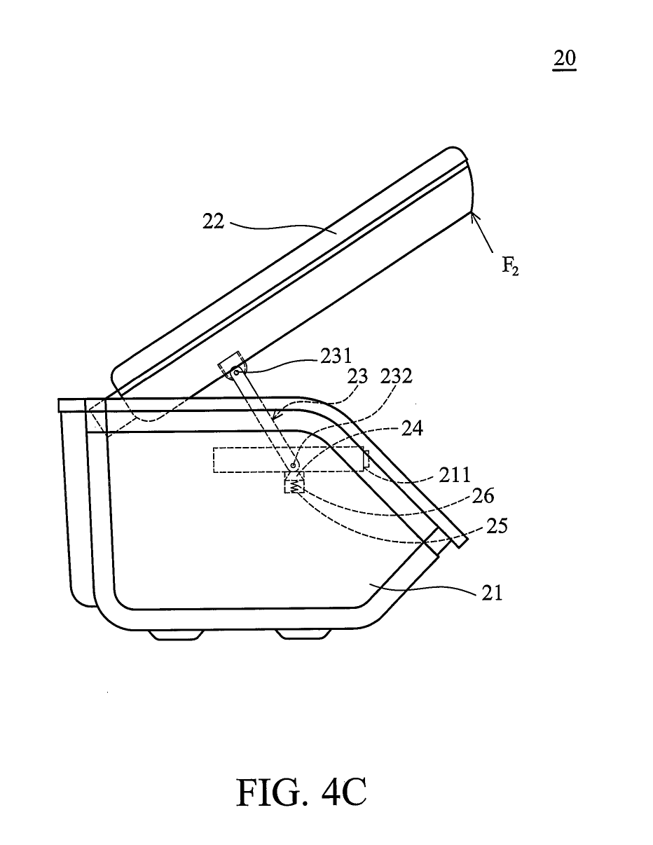

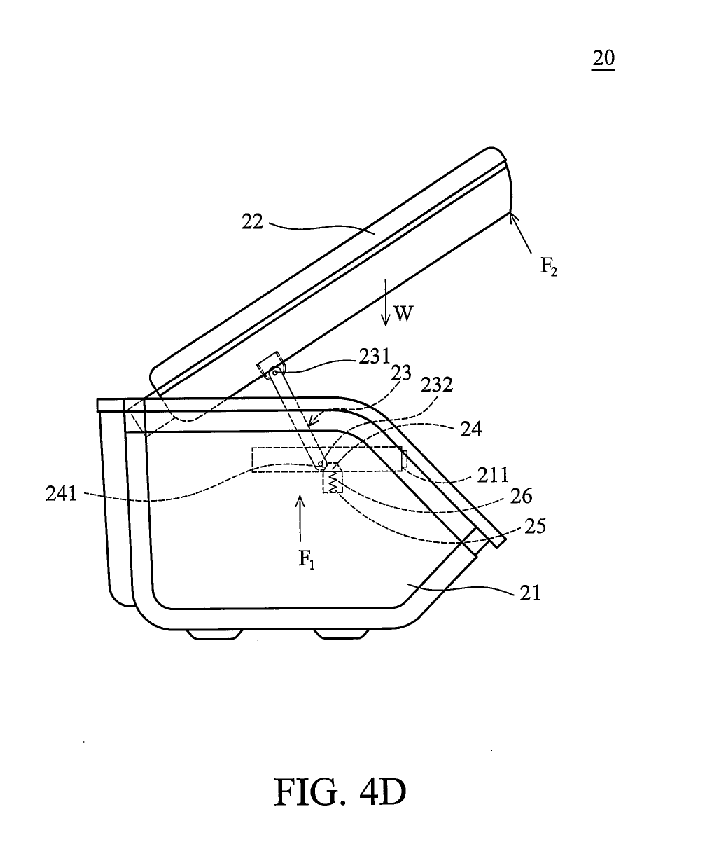

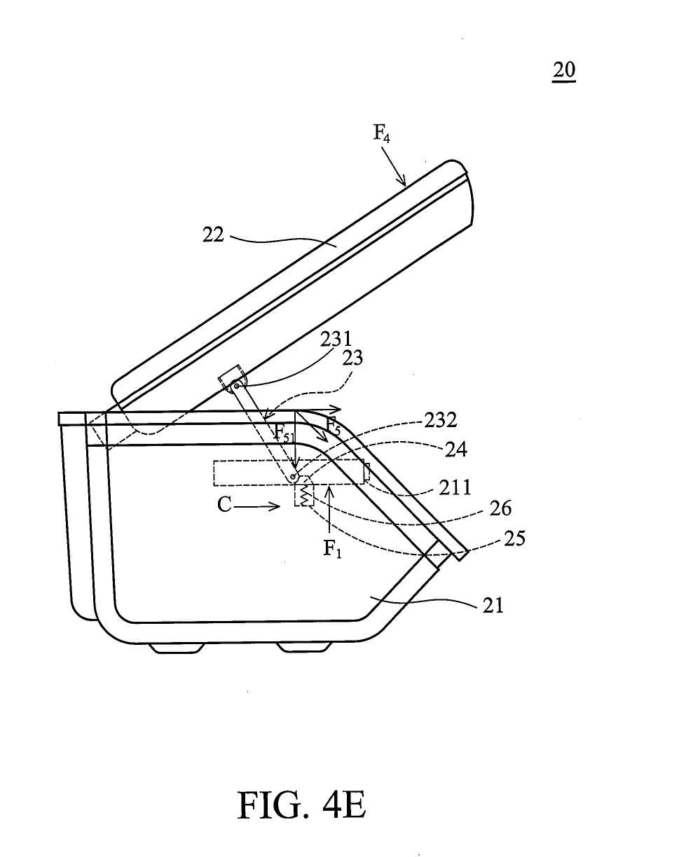

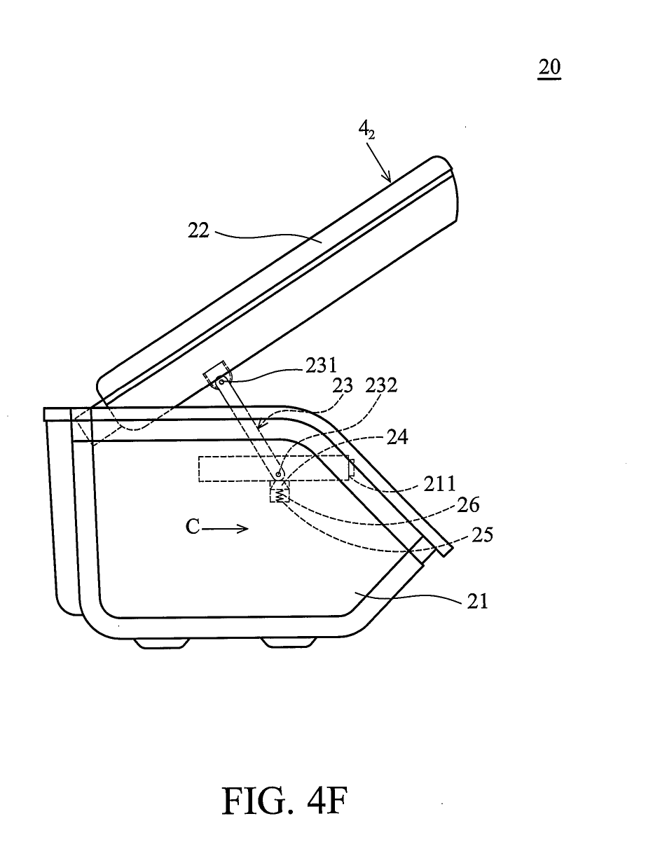

Referring to FIGS. 3B and 4A, two stop blocks 24 are installed in two sides of the guide groove 211. FIG. 4A, a sectional view along 4-4 of FIG. 2, shows the scanning device 22 in a closed state. The guide groove 211 comprises a hollow 25 and a first elastic element 26. The stop block 24 and first elastic element 26 are installed in the hollow 25. The first elastic element 26 is under the stop block 24 to provide an elastic force F1 to push the stop block 24 upward to protrude from the guide groove 211 where the stop block 24 is at a first position. In this embodiment, the first elastic element 26 is a spring, but the invention is not limited to a spring.

Referring to FIG. 4B, when an empty ink cartridge is replaced with a new one. A user exerts a force F2 to open the scanning device 22, thereby causing the supporting element 23 to move. The connecting end 232 moves along an arrow B in the guide groove 211 and forces a force F3 to the stop block 24. Because the force F31, a vertical component of the force F2, is greater than the elastic force F1 from the first elastic element 26, the stop block is pressed to sink in the hollow 25 for the connecting end 232 to pass thereon. A second position where stop block 24 locats is shown by FIG. 4C.

Referring FIG. 4D, after the supporting element 23 passes the stop block 24, an elastic force F1 from the first elastic element 26 pushes the stop block 24 upward to protrude from the guide groove 211 again, therefore the stop block 24 returns to the first position. Because the connecting end 232 is propped against a stop surface 241 of the stop block 24 protruding from the guide groove 211, the scanning device 22 stays open and a user can then stop the force F2 exerted thereon. Moreover, the force F1 from the first elastic element 26 is greater than the weight W of the scanning device 22 for propping up the connecting end 232.

Referring to FIG. 4E, when a user closes the scanning device 22, a force F1 exerted thereon and then affects the supporting element 23 to move and the connecting end 232 to slide along an arrow C in the guide groove 211. The stop block 24 is moved by the force F5. Because the force F51, a vertical component of the force F5, is greater than the elastic force F1 from the first elastic element 26, the stop block is pressed to sink in the hollow 25(the second position shown by FIG. 4F) for the connecting end 232 to pass thereon. The connecting end 232 continues moving along the arrow C until the scanning device 22 closes.

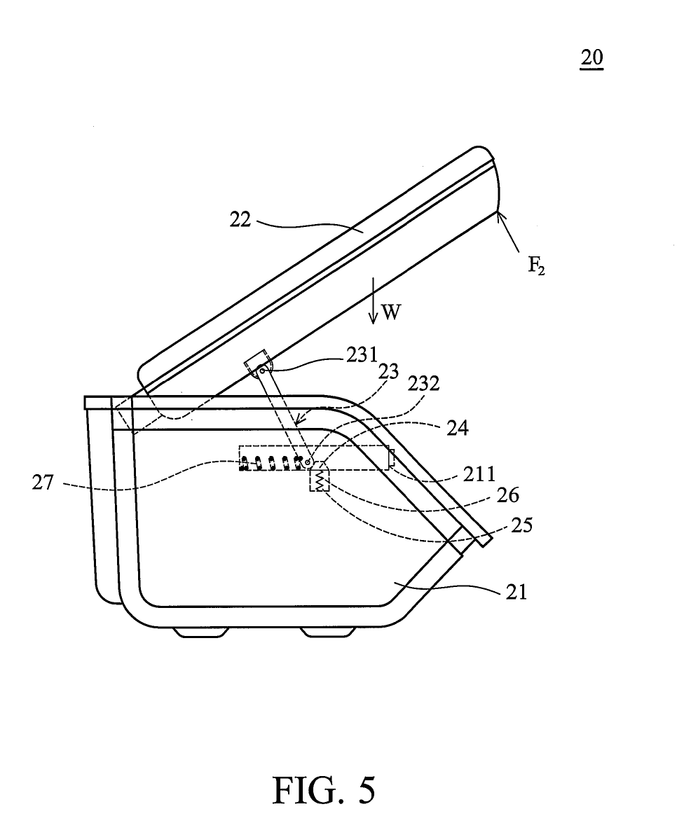

Referring to FIG. 5,the printing device 21 further comprises a second elastic element 27 installed in the guide groove 211 and connected between one end of the guide groove 211 and the connecting end 232. The second elastic element 27 is a compression spring or an extension spring to cushion movement of the connecting end 232 in the guide groove 211 to avoid breakage of the connecting end 232.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A supporting structure of a multifunction machine, wherein the multifunction machine comprising a printing device and a scanning device, the supporting structure comprising:
a supporting element comprising two connecting ends connected to the printing device and the scanning device respectively; and
a guide groove comprising at least a stop block, the stop block comprising a stop surface;
wherein one of the connecting ends of the supporting element is installed in the guide groove movably; and
when the scanning device moves from a closed position to an open position, the connecting end in the guide groove passes the stop block and is then propped up against the stop surface for keep the scanning device open at a predetermined angle.

2. The supporting structure as claimed in claim 1, wherein the guide groove further comprises a hollow and a first elastic element in the hollow; the stop block in a first position protrudes from the guide groove and thereby stops the connecting end in the guide groove from sliding; the stop block in a second position sinks in the guide groove for the connecting end in the guide groove to pass thereon.

3. The supporting structure as claimed in claim 2, wherein the first elastic element provides an elastic force to push the stop block to protrude from the guide groove.

4. The supporting structure as claimed in claim 3, wherein the first elastic element comprises a spring.

5. The supporting structure as claimed in claim 1, wherein the guide groove is installed in the printing device.

6. The supporting structure as claimed in claim 1, further comprising a second elastic element in the guide groove, wherein the second elastic element connected to the connecting end in the guide groove.

7. The supporting structure as claimed in claim 6, the second elastic element comprises a compression spring or an extension spring.

8. A multifunction machine, comprising:
a printing device;
a scanning device, disposed on the printing device pivotally; and
a supporting structure comprising:
a supporting element comprising two connecting ends connected to the printing device and the scanning device respectively; and
a guide groove comprising at least a stop block, the stop block comprising a stop surface;
wherein one of the connecting ends of the supporting element is installed in the guide groove movably; and
when the scanning device moves from a close position to an open position, the connecting end in the guide groove passes the stop block and then is propped against the stop surface for keep the scanning device open at a predetermined angle.

9. The multifunction machine as claimed in claim 8, wherein the guide groove further comprises a hollow and a first elastic element in the hollow; the stop block in a first position protrudes from the guide groove and thereby stops the connecting end in the guide groove from sliding; the stop block in a second position sinks in the guide groove for the connecting end in the guide groove to pass thereon.

10. The multifunction machine as claimed in claim 8, further comprising a second elastic element in the guide groove, wherein the second elastic element is connected to the connecting end in the guide groove.
